(19) United States
(12) Patent Application Publication
(10) Pub. No.: US 2019/0329707 A1
(43) Pub. Date: Oct. 31, 2019

(54) SEATBELT VIBRATING UNIT AND SEATBELT APPARATUS

(71) Applicant: NIDEC COPAL CORPORATION, Tokyo (JP)

(72) Inventors: Shinsuke OKAYASU, Tokyo (JP); Kazuya MOCHIDA, Tokyo (JP)

(73) Assignee: NIDEC COPAL CORPORATION, Tokyo (JP)

(21) Appl. No.: 16/392,708

(22) Filed: Apr. 24, 2019

(30) Foreign Application Priority Data
Apr. 27, 2018 (JP) 2018-086771

(51) Int. Cl. B60Q 9/00; B60R 16/03

(52) U.S. Cl. CPC B60Q 9/00; B60R 22/18; B60R 16/03

(57) ABSTRACT

A seatbelt vibrating unit for transmitting a vibration through a seatbelt to the body of a seatbelt user, comprising a base plate that can be connected to the seatbelt; an elastic contacting body that is secured to the base plate and that has a body contacting surface on the back face side thereof; and a vibrating device that is secured to the elastic contacting body in a state that enables fine motion in relation to the base plate.

### CROSS REFERENCE TO RELATED APPLICATIONS

This application claims priority to Japanese Application No. 2018-086771 filed Apr. 27, 2018. This application is incorporated herein by reference in its entirety.

### FIELD OF THE INVENTION

The present invention relates to a seatbelt vibrating unit and seatbelt apparatus that transmit a vibration to the body of a user of a seatbelt.

### BACKGROUND

When operating a vehicle, driver dozing can lead to a serious accident, and thus there is prior art wherein whether or not a driver is dozing is detected by a variety of biological status sensors, or the like, wherein a vibration is applied to the steering wheel or to the seat if it is determined that the driver has fallen asleep, to thereby arouse the driver (referencing, for example, Japanese Unexamined Patent Application Publication 2005-211239).

The technology that causes the steering wheel or seat to vibrate may also be used as means for responding to an operation of, for example, the HVAC (heating, ventilation, and air conditioning) system, an A/V (audiovisual) device, or the navigation system. However, because, in the prior art, the object being vibrated, such as the steering wheel, seat, or the like, is of relatively high mass, it is necessary to use a vibrating device with a large vibrational power as the vibration source.

Furthermore, when vibrating the seat, the vibration is applied to a position such as the back or the thigh of the driver, wherein the threshold for discrimination is relatively high, making it difficult to attract the attention of the driver. Because of this, it is necessary to further increase the vibrational power of the vibrating device.

### SUMMARY

In order to solve such a problem, the present invention is provided with the following structures:

A seatbelt vibrating unit for transmitting a vibration through a seatbelt to the body of a seatbelt user, comprising: a base plate that can be connected to the seatbelt; an elastic contacting body, secured to the base plate, and having a body contacting surface on the back face side thereof; and a vibrating device that is secured to the elastic contacting body in a state that enables fine motion relative to the base plate.

### BRIEF DESCRIPTIONS OF THE DRAWINGS

FIG. 1 is a schematic diagram depicting an example of a seatbelt apparatus equipped with a seatbelt unit according to the present invention.

FIG. 2 is a plan view depicting the critical portions of this seatbelt apparatus.

FIG. 3 is a perspective diagram depicting the critical portions of this seatbelt apparatus.

FIG. 4 is a plan view wherein the critical portions of this seatbelt apparatus are enlarged.

FIG. 5 is a cross-sectional drawing along the section (V)-(V) in FIG. 4.

FIG. 6 is a cross-sectional drawing, sectioned in the same position as in FIG. 5, for another example of a seatbelt unit according to the present invention.

FIG. 7 is a cross-sectional drawing, sectioned in the same position as in FIG. 5, for another example of a seatbelt unit according to the present invention.

### DETAILED DESCRIPTION

Embodiments according to the present invention will be explained below in reference to the drawings. In the descriptions below, identical reference symbols in the different drawings below indicate positions with identical functions, and redundant explanations in the various drawings are omitted as appropriate.

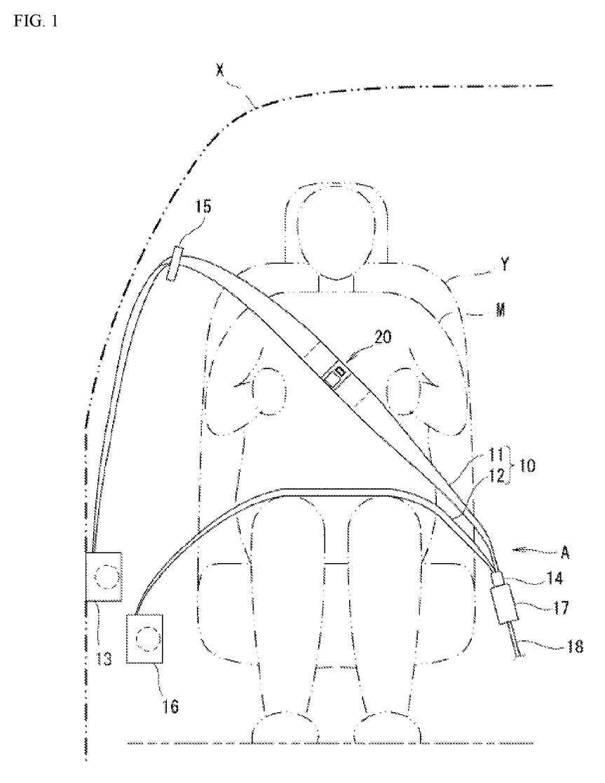

FIG. 1 depicts an example of a seatbelt apparatus comprising a seatbelt vibrating unit according to the present invention.

This seatbelt apparatus A comprises a seatbelt 10 and a seatbelt vibrating unit 20 for transmitting a vibration through this seatbelt 10 to the body of a seatbelt user M, and is equipped together with a seat Y in a vehicle X.

The seatbelt 10 comprises a chest belt 11 that fastens around the chest of the seatbelt user M, and a waist belt 12 that fastens around the waist of the seatbelt user M.

The chest belt 11 is a long belt-shaped flexible member, and connects to a secure position on the vehicle X side through a tongue 14 and buckle 17, and an anchor belt 18, or the like.

Explaining in detail, one end side of the chest belt 11 is connected to a chest retractor 13 at a lower portion side of the vehicle X. The other end side of the chest belt 11 is inserted into a guide hole of a shoulder anchor 15 at an upper portion side of the vehicle X, and is connected to a tongue 14.

Additionally, the waist belt 12 is a flexible member is similar to the chest belt 11, with one end side connected to a waist retractor 16 at the lower portion side of the vehicle X, and the other end side is connected to the tongue 14. The tongue 14 is inserted into a buckle 17, at the vehicle-width direction center side of the vehicle X, to engage removably therewith.

The buckle 17 is secured to a secured position (not shown) on the vehicle X side through the anchor belt 18.

The chest retractor 13 and the waist retractor 16 are each well-known mechanisms that coil-in and feed-out the chest belt 11 and the waist belt 12, respectively, and lock the feed operation when the chest belt 11 or waist belt 12 is pulled out abruptly.

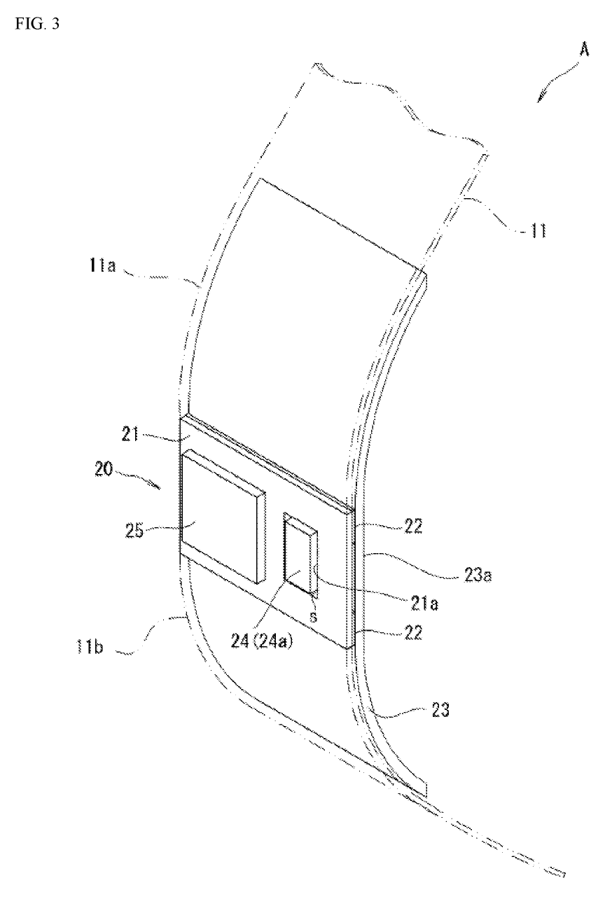

The seatbelt vibrating unit 20, as illustrated in FIG. 3, comprises: a base plate 21 that is connected to the chest belt 11; an elastic contacting body 23, which is secured through an elastic portion 22 to the base plate 21, and that has a body contacting surface 23a on the back face side thereof; a vibrating device 24 that is secured to the elastic contacting body 23 in a state wherein fine motion relative to the base plate 21 is possible; and a controlling portion 25, equipped on the base plate 21, for controlling the supply of electric power to the vibrating device 24.

The base plates 21 is formed in a flat plate-shape from a hard material such as, for example, a metal, and has a recessed portion 21a that is open on at least the back face side (the elastic contacting body 23 side).

The recessed portion 21a that is illustrated is a hole that passes through the base plate 21 in the thickness direction thereof. The side face of the recessed portion 21a has a gap s from the outside face of the vibrating device 24, so as to not contact the vibrating device 24.

The other side of the recessed portion 21a may be in the form of a closed-bottom hole, which is open on only the back face side, where, in this form as well, preferably a gap s is provided, from the outside face and front face of the vibrating device 24, so as to not interfere with the vibration of the vibrating device 24.

Given this, the elastic contacting body 23 is secured through one or more (being two in the example that is illustrated) elastic portions 22, to the back face of the base plate 21.

The elastic portion 22 is formed in a flat plate shape from an elastic material, such as rubber, an elastic resin material, or the like, and is disposed unit two parts, on both sides, with the vibrating device 24 in the middle.

In the illustrated example, the individual elastic portions 22 are positioned on one end side and the other end side of the base plate 21, along the lengthwise direction of the chest belt 11, and each is bonded adhesively to the back face of the base plate 21.

Moreover, the elastic contacting body 23 is formed in a flat plate shape from an elastic material having a hardness that is greater than that of the elastic portion 22, and is adhesively bonded to a plurality of elastic portions 22.

The back face of the elastic contacting body 23 functions as the body contacting surface 23a for contacting the chest of the seatbelt user M. In the elastic contacting body 23, the area of the body contacting surface 23a is set as appropriate so as to transmit the vibration of the vibrating device 24 efficiently to the seatbelt user M. In the example that is illustrated, the elastic contacting body 23 is formed with an area that is greater than that of the base plate 21, in a long belt shape along the lengthwise direction of the chest belt 11.

The vibrating device 24 may be configured so that the case 24a, which has the shape of the mechanism that is contained therein, is vibrated thereby. The vibrating device 24 uses, for example, a linear vibration motor of a well-known structure that applies a vibration in the lengthwise direction of the chest belt 11 to a movable element within the case 24a through the application of AC power.

Note that, as other examples of vibrating devices 24, the form may be one wherein the movable element is vibrated in a direction perpendicular to the lengthwise direction of the chest belt 11, a form wherein a vibration is produced through rotating an eccentric movable element, or the like.

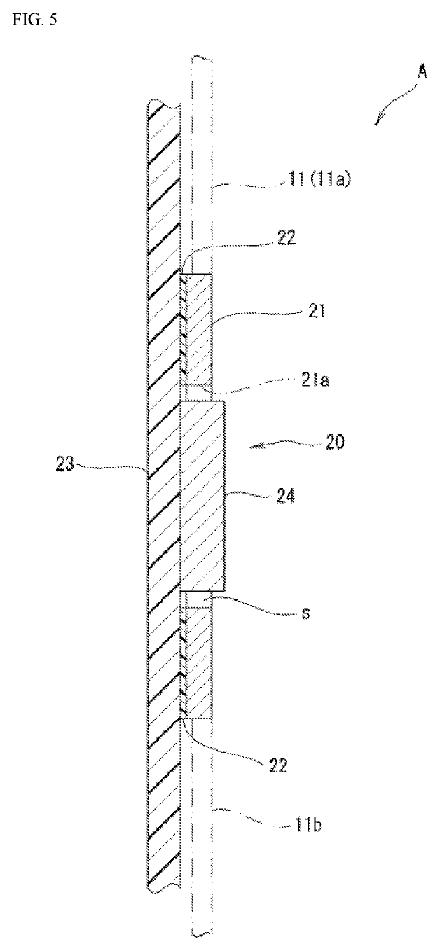

The case 24a of the vibrating device 24, in the example that is illustrated, is formed in a rectangular parallelepiped shape, and is equipped in the recessed portion 21a, with a gap s from the base plate 21. The back face of this case 24a is adhesively bonded to the surface of the elastic contacting body 23 (referencing FIG. 5).

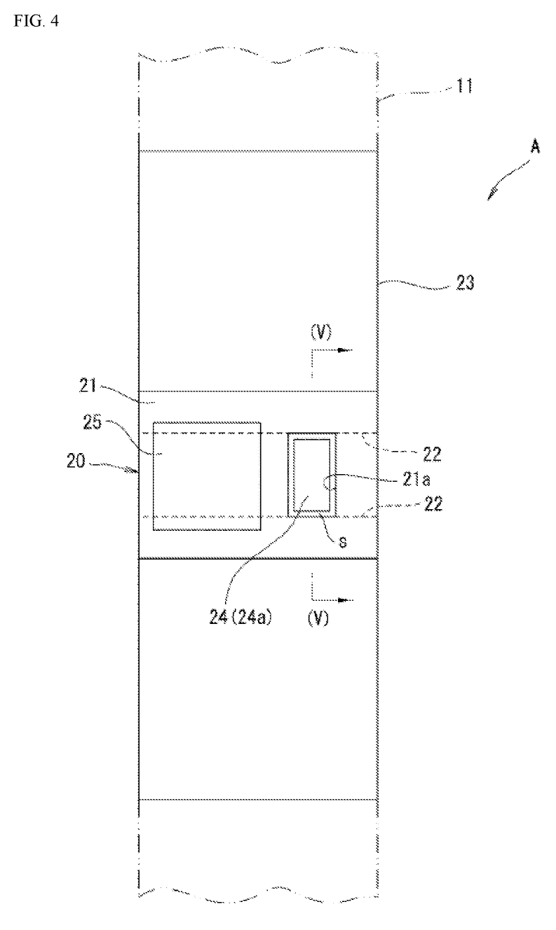

Consequently, the case 24a, accompanying vibration of the internal movable element (not shown), is able to undergo slight movement (fine motion) in the direction along the surface of the base plate 21 (the vertical and crosswise direction in FIG. 4), and is also able to undergo slight movement (fine motion) in the thickness direction of the base plate 21 (the crosswise direction in FIG. 5).

A controlling portion 25 is equipped with a power supply circuit for supplying electric power to the vibrating device 24, a controlling circuit for turning ON/OFF the vibrating device 24, and the like.

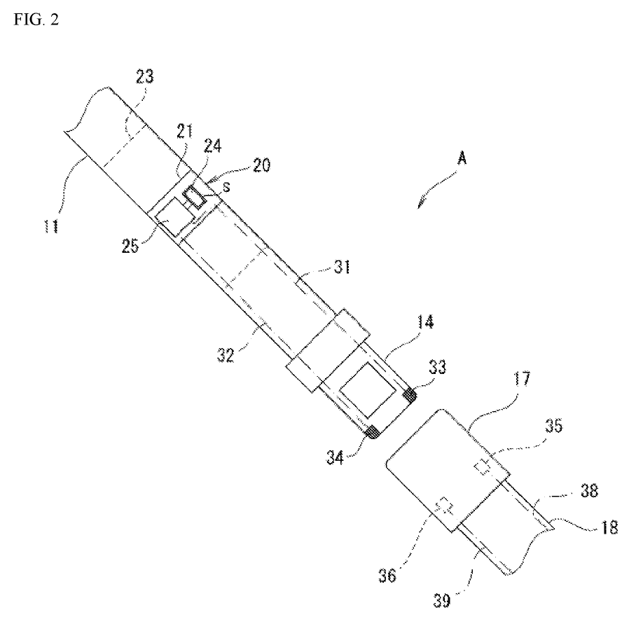

This controlling portion 25 is connected electrically to the vibrating device 24 through a power line or a flexible base plate, or the like, not shown, to control, in response to an input from a signal line 32, the electric power that is transmitted by a power supply line 31, described below (referencing FIG. 2), to supply the power to the vibrating device 24.

This controlling portion 25, in the example that is illustrated, is adhesively bonded to the surface of the base plate 21; however, it instead may be configured enclosed in the base plate 21, or configured integrally with the base plate 21.

The seatbelt vibrating unit 20, structured as described above, is installed on the chest belt 11 in the seatbelt 10 that has been explained above. The chest belt 11 is connected to the base plates 21 in a state that is not in direct contact with the vibrating device 24.

That is, in an example that is illustrated in FIG. 3, the chest belt 11 is structured from two parts, comprising one half portion 11a that is positioned on one side in the lengthwise direction thereof, and another half portion 11b that is positioned on the other side, where an end portion of the one half portion 11a is connected to an end portion of the base plate 21, and an end portion of the other half portion 11b is connected to the end portion on the other side of the base plate 21.

The means for connecting the one half portion 11a and the base plate 21, and for connecting the other half portion 11b and the base plate 21, may use arbitrarily, for example, fitting, bonding, screwing, or other well-known connecting means, to produce adequate tensile strength. Note that these connecting means may be in a removable form.

Consequently, the chest belt 11 is connected to the base plate 21 in a state wherein it is not in contact with the vibrating device 24, arranged so as to tend not to have an effect on the vibration of the vibrating device 24.

Given the structure described above, the vibrating device 24 is not in direct contact with the chest belt 11, and is not in direct contact with the base plate 21 either, and is secured in direct contact with the elastic contacting body 23. Because of this, the vibrating device 24 is in a state wherein it can vibrate easily, independently from the base plate 21 and the chest belt 11.

The electrical connection to the seatbelt vibrating unit 20 will be explained next.

The path of the electrical line to the seatbelt vibrating unit 20 is provided spanning the tongue 14 and the buckle 17, and is connected and disconnected accompanying connection and disconnection of the tongue 14 and the buckle 17.

Explaining in detail, the electrical line route, as illustrated in FIG. 2, is structured comprising power supply lines 31 and 38 that transmit electric power for driving the vibrating device 24, signal lines 32 and 39 for turning the vibrating device 24 ON/OFF, terminals 33 through 36 for connecting these electrical lines between the tongue 14 and the buckle 17, and the like.

The power supply lines 31 and 38 and signal lines 32 and 39 are flexible power lines, such as flat cables.

The power supply line 31 and signal line 32 are each provided along the chest belt 11, with one end side thereof connected electrically to the controlling portion 25, and the other end side thereof connected electrically to terminals 33 and 34 that are provided on the tip end side of the tongue 14.

The power supply line 38 and signal line 39 are provided along the anchor belt 18, with one and side connected to the terminals 35 and 36 within the buckle 17, and the other end side connected to the power supply circuit of the vehicle X, a controlling circuit, or the like.

The terminals 33 and 34 and the terminals 35 and 36 are connected electrically when the tongue 14 is inserted into the buckle 17, to form an electrical line route for supplying power to, and controlling, the vibrating device 24. When the tongue 14 is removed from the buckle 17, the terminals 33 and 34 and the terminals 35 and 36 are separated from each other, disconnecting the aforementioned electrical line routes.

In an example according to the present invention, the power supply lines 31 and 38 and terminals 33 and 35 are disposed, respectively, on the front face side and the back face sides of the chest belt 11, the tongue 14, the buckle 17, and the anchor belt 18, to structure the electrical line routes. Given this, the electrical line routes on the front face side and back face side use different polarities (+/−), so as to apply AC power to the vibrating device 24.

Note that, as another example, these power supply lines 31 and 38 and terminals 33 and 35 may all be provided on one surface side alone.

The signal lines 32 and 39, and terminals 34 and 36 thereof, may also be provided on the front and back, in the same manner as with the aforementioned power supply lines, or, on the other hand, may be provided on one surface side alone.

Note that these signal lines 32 and 39, and the terminals 34 and 36 thereof, may be obviated through the use of near-distance wireless communicating means such as Bluetooth (registered trademark), or the like.

The distinctive effects of operation will be explained in detail next for the seatbelt vibrating unit 20 and seatbelt apparatus A, structured as described above.

When the vibrating device 24 vibrates, that vibration is transmitted from the back face side of the vibrating device 24 to the elastic contacting body 23.

At this time, the vibrating device 24, on the sides thereof, is not in contact with the base plate 21 or the chest plate 11, thus enabling the vibration of the vibrating device 24 to be transmitted to the base plate 21 and the chest belt 11, and preventing loss thereof.

In the particularly preferred example that is illustrated, an elastic portion 22 that has hardness less than that of the elastic contacting body 23 is interposed between the elastic contacting body 23 and the base plate 21, and thus the vibration of the elastic contacting body 23 is transmitted to the base plate 21, and attenuation is prevented effectively.

This enables the elastic contacting body 23 to be vibrated with a relatively large vibration.

Given this, the elastic contacting body 23 contacts the seatbelt user M with a relatively large area, doing so elastically so as to not slip. Because of this, the vibration of the elastic contacting body 23 is transmitted effectively to the seatbelt user M.

Furthermore, the discrimination threshold for most people is smaller on the chest than for the back or the thigh. Because of this, the vibration by the seatbelt vibrating unit 20 can be sensed with high sensitivity by the seatbelt user M.

For example, if, in response to detection of dozy driving, by the biological state sensor, or the like, the seatbelt vibrating unit 20 is vibrated, or the seatbelt vibrating unit 20 is vibrated in response to an operation any of a variety of onboard devices (the HVAC system, an AV device, or the like), that vibration can be relayed effectively to be sensed by the seatbelt user M.

Additionally, as described above, the elastic contacting body 23 can be caused to vibrate with a relatively large vibration, to cause the seatbelt user M to sense this vibration effectively, making it possible to use a vibrating device 24 that has a relatively low vibration power.

Another specific form will be explained next for the seatbelt apparatus A. Note that the embodiment below is one wherein a portion of the seatbelt apparatus A, described above, has been changed, so the modified part will be explained in detail, and redundant detailed explanations will be omitted.

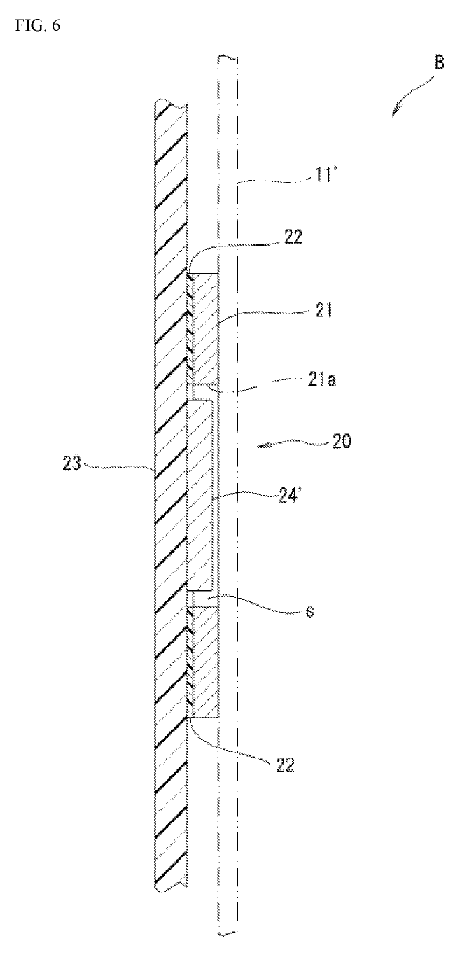

In the seatbelt apparatus B depicted in FIG. 6, the chest belt 11, structured from the one half portion 11a and the other half portion 11b in the seatbelt apparatus A, is replaced with a single belt-shaped chest belt 11′ that is not divided, and the vibrating device 24 is replaced with a vibrating device 24′.

The back face side of a part in the middle of the chest belt 11′, in the lengthwise direction, is secured to the base plate 21. The securing means may be, for example, adhesive bonding, screwing, fitting, or the like.

The vibrating device 24′ has the same structure as that of the vibrating device 24 described above, structured so as to be within the thickness of the base plate 21, so that the surface thereof does not protrude from the surface of the base plate 21.

Additionally, although not depicted in the drawings, the controlling portion 25 is also structured within the thickness of the base plate 21, so as to not protrude from the surface of the base plate 21.

This seatbelt apparatus B enables the vibration of the vibrating device 24′ to be relayed efficiently to the elastic contacting body 23, in the same manner as with the seatbelt apparatus A, described above, enabling the vibration to be sensed with high sensitivity by the seatbelt user M.

Furthermore, with the seatbelt apparatus B, the seatbelt vibrating unit 20 is attached to a part in the middle of a continuous chest belt 11′, thus enabling provision on existing seatbelts to be easy as well.

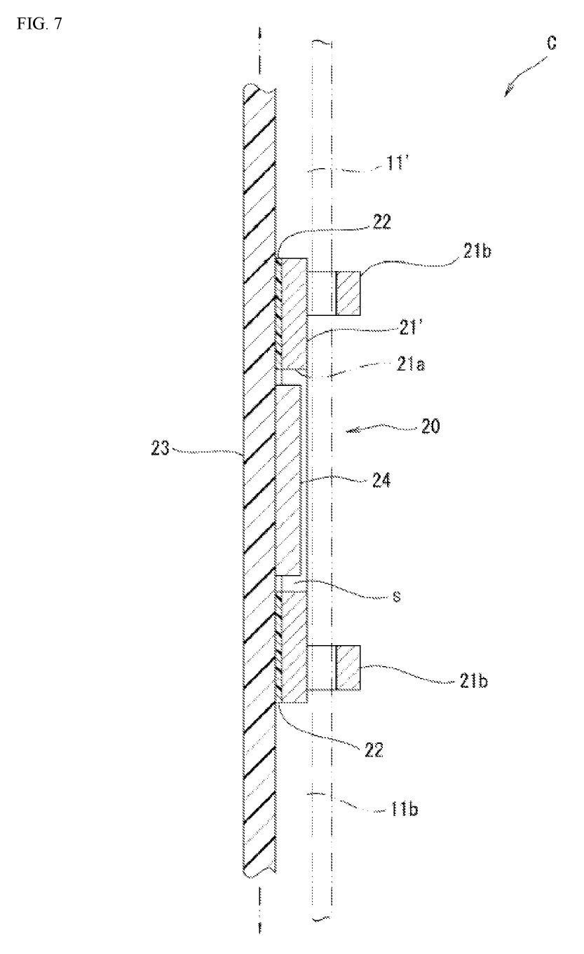

Moreover, in the seatbelt apparatus C that is depicted in FIG. 7, the base plate 21 of the seatbelt apparatus B, described above, is replaced by a base plate 21′, where the seatbelt vibrating unit 20 can be moved in relation to the chest belt 11′.

The base plate 21′ is configured with ring portions 21b that are provided integrally on one end side and the other end side of the base plate 21 that is described above.

The chest belt 11′ is inserted, in a state wherein there is a slight amount of slack, into the ring portions 21b on both end sides. Through this, the seatbelt vibrating unit 20 is able to move in respect to the chest belt 11′ in the lengthwise direction.

In this seatbelt apparatus C, the supply of power to the seatbelt vibrating unit 20 may be through the provision of a power line that is separate from the chest belt 11′, for example, or batteries that are provided integrally with the base plate 21′ may be used. Moreover, the signal input to the seatbelt vibrating unit 20 may use, for example, near-distance wireless communicating means, described above, or the like.

Through this, the seatbelt apparatus C enables the vibration of the vibrating device 24′ to be transmitted efficiently to the elastic contacting body 23 in the same manner as with the seatbelt apparatuses A and B, described above, enabling the vibrations to be sensed with high sensitivity by the seatbelt user M.

Furthermore, this seatbelt apparatus C enables the position of the seatbelt vibrating unit 20 to be adjusted through movement relative to the chest belt 11′.

Note that, given the embodiments described above, a particularly preferred form is one wherein the gap s is provided between the vibrating devices 24, 24′ and the base plates 21, 21′, but as another example it may be in a form wherein the gap s is omitted, with the vibrating devices 24, 24′ and the base plates 21, 21′ in a sliding contact.

Moreover, while, in the embodiments set forth above, the seatbelt apparatus was structured with an end portion of the chest belt 11 and an end portion of the waist belt 12 connected to the tongue 14, this seatbelt apparatus may instead have a form other than that which is illustrated, insofar as it contacts at least the chest of the seatbelt user M.

For example, as another example of a seatbelt apparatus, a typical seatbelt wherein the tongue is installed so as to enable movement relative to the belt may be used. Explain in detail, in this seatbelt apparatus, a seatbelt (not shown) that has a belt shape wherein the chest belt portion and the waste belt portion are a single unit is used, where one end side of this seatbelt is connected to the chest retractor 13 and the other end side of the seatbelt is inserted into a ring portion (not shown) of the tongue, after insertion into the shoulder anchor 15, and secured to a secured position of the vehicle X below the chest retractor 13.

In this form, the supply of power to the seatbelt vibrating unit may use, for example, a cable that is separate from the aforementioned belt, which is a single unit, or may use batteries. Moreover, the signal input to the seatbelt vibrating unit 20 may use the near-distance wireless communicating means, described above, or the like.

While embodiments according to the present invention were described in detail above, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. A seatbelt vibrating unit for transmitting a vibration through a seatbelt to the body of a seatbelt user, comprising:
a base plate that can be connected to the seatbelt;
an elastic contacting body, secured to the base plate, and having a body contacting surface on the back face side thereof; and
a vibrating device that is secured to the elastic contacting body in a state that enables fine motion relative to the base plate.

2. The seatbelt vibrating unit as set forth in claim 1, wherein: a gap is secured between the vibrating device and the base plate.

3. The seatbelt vibrating unit as set forth in claim 1, wherein: the base plate has a recessed portion that is open on at least the back face side thereof; and the vibrating device is provided within the recessed portion.

4. The seatbelt vibrating unit as set forth in claim 1, wherein: the base plate is secured to the elastic contacting body through an elastic portion made from an elastic material having a hardness that is less than that of the elastic contacting body.

5. The seatbelt vibrating unit as set forth in claim 1, wherein: a controlling portion for controlling a supply of electric power to the vibrating device is provided on the base plate.

6. The seatbelt apparatus wherein a seatbelt vibrating unit as set forth in claim 1 is provided on a seatbelt, wherein:
the seatbelt is connected to the base plate in a state wherein the seatbelt is not in contact with the vibrating device.

7. The seatbelt apparatus as set forth in claim 6, wherein: an electrical line to the seatbelt vibrating unit is provided along the seatbelt.

8. The seatbelt apparatus as set forth in claim 6, wherein the seatbelt is connected removably to a securing position through a tongue and buckle, and
wherein a route for the electrical line is provided spanning the tongue and the buckle, and the path is connected and disconnected accompanying connection and disconnection between the tongue and the buckle.
